(19) United States
(12) Patent Application Publication
(10) Pub. No.: US 2010/0314172 A1
(43) Pub. Date: Dec. 16, 2010

(54) SHAFT CATCH

(75) Inventors: Lance D. Underwood, Cypress, TX (US); James Edmond Beylotte, Crosby, TX (US)

Correspondence Address: OSHA, LIANG LLP / SMITH, TWO HOUSTON CENTER, 909 FANNIN STREET, SUITE 3500, HOUSTON, TX, 77010, US

(73) Assignee: Smith International ,Inc., Houston, TX (US)

(21) Appl. No.: 12/485,805

(22) Filed: Jun. 16, 2009

(51) Int. Cl. E21B 4/02; E21B 7/00; B23P 11/00

(52) U.S. Cl. 175/57; 175/101; 29/525.11

(57) ABSTRACT

A turbodrill includes a housing having a central axis, a motor assembly disposed within the housing and comprising non-rotating stator vanes fixed to the housing, and a rotor assembly having rotating vanes fixed to a shaft of the turbodrill, a locking clutch configured to selectively transmit torque from the turbine housing to the rotor by preventing rotation of the housing and the rotor relative to each, and a catch device configured to retain a severed lower section of the shaft with the turbodrill.

### BACKGROUND

1. Field of the Disclosure

Embodiments disclosed herein relate generally to rotary downhole tools. Particularly, embodiments disclosed herein relate to a shaft catch for rotary downhole tools.

2. Background Art

Drilling motors are commonly used to provide rotational force to a drill bit when drilling earth formations. Drilling motors used for this purpose are typically driven by drilling fluids pumped from surface equipment through the drill string. This type of motor is commonly referred to as a mud motor. In use, the drilling fluid is forced through the mud motor(s), which extract energy from the flow to provide rotational force to a drill bit located below the mud motors. There are two primary types of mud motors: positive displacement motors (“PDM”) and turbodrills.

FIG. 1 shows a prior art turbodrill. A housing 45 includes an upper connection 40 to connect to a drillstring (not shown). A turbine motor assembly 80 includes multiple turbine stages within the housing 45 which rotate a shaft 50. At a lower end of the turbodrill, a drill bit 90 is attached to the shaft 50 through a lower connection (not shown). A radial bearing 70 is provided between the shaft 50 and the housing 45. Stabilizers 60 and 61 disposed on the housing 45 help keep the turbodrill centered within the wellbore.

The motor assembly 80 of the turbodrill provides rotational force to the drill bit 90. The motor assembly 80 includes multiple stages, each consisting of a non-moving stator vane and a rotor assembly, which has rotating vanes mechanically linked to the shaft 50. Preferably, the stages are designed such that the vanes of the stator stages direct the flow of drilling mud into corresponding rotor blades to provide rotation to the shaft, which ultimately connects to and drives the bit 90. Thus, the high-speed drilling mud flowing into the rotor vanes causes the rotor and the bit 90 to rotate with respect to the stator housing 45. Historically, turbine motors have been characterized as having a high-speed, but low-torque output to the drill bit. Generally, the “stator” portion of the motor assembly is the portion of the motor body that is attached to, and rotates at the same speed, as the remainder of the drillstring and a bottomhole assembly (“BHA”). Typically, the BHA may include drill bits, drill collars, stabilizers, reamers, mud motors, rotary steering tools, measure-while-drilling sensors, and any other devices useful in subterranean drilling operations.

Turbodrills are characterized by high speed, low torque output, and therefore, drill bits attached thereto may be more susceptible to becoming stuck when encountering certain formations. This occurs when the torque needed to rotate the bit becomes greater than the torque which the motor vanes (the stator and rotor vanes of the motor assembly) are able to generate. In the event a drill bit becomes stuck during “rotary” drilling (i.e., drilling in which only drill string rotation is used to drive the bit), it is a common practice to apply a large torque at the surface through the entire drillstring to free the drill bit. However, in cases in which downhole motors are used (such as the turbine motor), the rotation between the rotor and stator may prevent the transmission of torque from the drillstring to the drill bit. As a result, the only torque that may be transmitted to a stuck drill bit to free the bit is the torque that the downhole motor is able to produce. Because turbine motors generate relatively low torque, they may not be able to dislodge a stuck drill bit.

To solve this problem, a locking clutch may be used that is capable of selectively transmitting torque from the turbine housing to the rotor, which provides a rotational link between the housing and the rotor. In other words, the locking clutch prevents rotation of the housing and the rotor relative to each other when engaged. Generally, to prevent stalling of the drill bit and motor, the locking clutch may be configured to engage and apply torque from the housing (i.e., a stator) to the rotor when the rotational speed of the rotor no longer exceeds that of the rotational speed of the housing (i.e., when the relative rotation between the housing and the rotor is zero). When this occurs, the locking clutch mechanically engages, or couples the rotating housing with the rotor, and in doing so imparts rotation to the bit and frees the bit from sticking.

In some instances, modifications made to a lower end of the shaft to accommodate the locking clutch may include reducing a diameter of the shaft, milling pockets in the shaft, or other modifications in the area in which the locking clutch is disposed. Due to the reduced cross-section of this particular area, the shaft may be weakened. The weakened shaft may be susceptible to fatigue failure such that if the shaft severed, the bit and a portion of the shaft would be left in the hole and would be very difficult, if not impossible, to retrieve using modern fishing tools and methods. Accordingly, there exists a need for a device that mitigates some of this risk by providing a means of retrieving the broken shaft and bit in the event of a failure.

### SUMMARY OF THE DISCLOSURE

In one aspect, embodiments disclosed herein relate to a turbodrill including a housing having a central axis, a motor assembly disposed within the housing and comprising non-rotating stator vanes fixed to the housing, and a rotor assembly having rotating vanes fixed to a shaft of the turbodrill, a locking clutch configured to selectively transmit torque from the turbine housing to the rotor by preventing rotation of the housing and the rotor relative to each, and a catch device configured to retain a severed lower section of the shaft with the turbodrill.

In other aspects, embodiments disclosed herein relate to a method of assembling a catch device on a turbodrill, the method including inserting a shaft sub-assembly having a flange disposed thereon into a lower end of a housing of the turbodrill and providing a lip on a component downhole of the flange, wherein the lip is configured to engage the flange on the shaft and prevent the flange from travelling in an axial direction downward past the lip.

In other aspects, embodiments disclosed herein relate to A method of retrieving a severed lower shaft of a turbodrill from a wellbore with the turbodrill, the method including providing a lip disposed on a housing component of the turbodrill downhole of a flange attached to the lower shaft, wherein the lip is configured to interfere with the flange and retrieving the severed lower shaft using the housing of the turbodrill.

Other aspects and advantages of the invention will be apparent from the following description and the appended claims.

### BRIEF DESCRIPTION OF DRAWINGS

FIG. 1 shows a prior art turbodrill.

FIG. 2A shows a cross-sectional view of a turbodrill bearing assembly in accordance with embodiments of the present disclosure.

FIG. 2B shows a detailed cross-sectional view of the turbodrill bearing assembly of FIG. 2A in accordance with embodiments of the present disclosure.

FIG. 2C shows an assembly view of a lower end of the turbodrill bearing assembly of FIG. 2A in accordance with embodiments of the present disclosure.

FIG. 3 shows a cross-sectional view of the lower end of the turbodrill bearing assembly of FIG. 2A in accordance with embodiments of the present disclosure.

FIGS. 4A and 4B show detailed views of the catch device of FIG. 3 in accordance with alternate embodiments of the present disclosure.

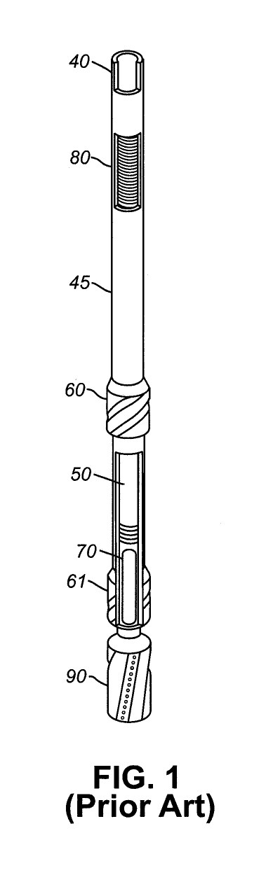

### DETAILED DESCRIPTION

In one aspect, embodiments disclosed herein relate to rotary downhole tools. More particularly, embodiments disclosed herein relate to a turbodrill having a shaft catch used to secure a severed lower shaft and drill bit to the turbodrill for removal from a wellbore.

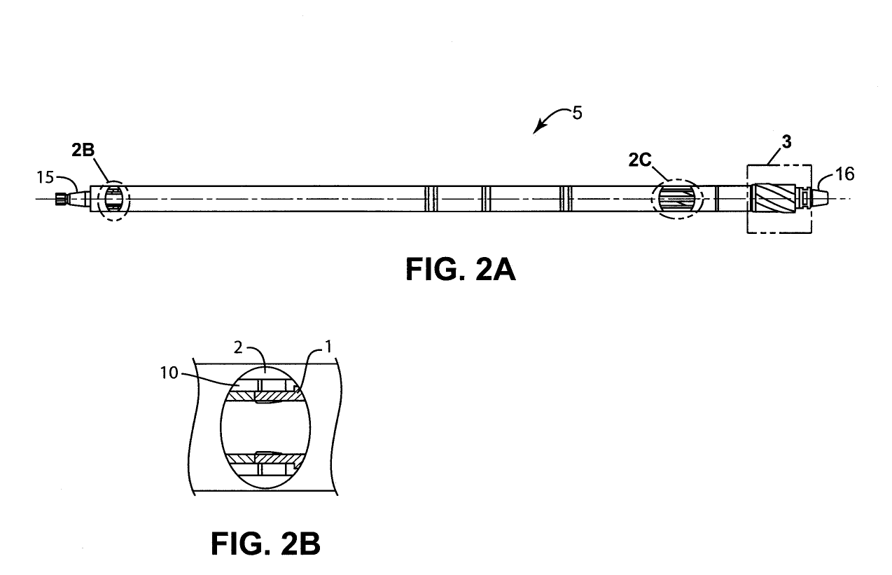

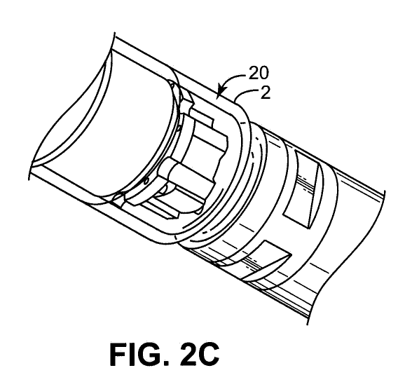

Referring initially to FIGS. 2A-2C, a downhole motor bearing assembly 5 in accordance with an embodiment of the present disclosure is shown. Particularly, as shown in FIG. 2A, the downhole motor bearing assembly 5 is driven by a turbodrill; however, those of ordinary skill in the art will appreciate that locking mechanisms in accordance with embodiment of the present disclosure may also be attached to positive displacement mud motors or electric motors, the housing (i.e., the stator) of which typically has the same characteristic in that it is rotationally disconnected from a rotor. FIG. 2A is representative of a turbine bearing assembly in that it has an upper connection 15 that is connected to a turbine power section and a lower connection 16 that is connectable to a drill bit (not shown). A housing 2 may contain several working components of motor bearing assembly 5 (e.g., journal bearings, thrust bearings, etc.), which those of ordinary skill in the art will be able to design without further disclosure. Both the upper connection 15 and the lower connection 16 are rotationally fixed relative to a rotor 1 (visible in FIGS. 2B and 2C).

The motor bearing assembly 5 is operated by pumping drilling fluid through the drillstring into an annular space 10. The flow of the drilling fluid is directed through a plurality of turbine vanes (located in a turbine power section portion, not shown, above upper connection 15) to provide rotational force upon rotor 1. After being used by the turbine vanes, the drilling fluid passes through the bearing assembly 5 and continues through lower connection 16. Those having ordinary skill in the art will be able to design suitable motor portions for providing rotational force. To selectively transmit torque from housing 2 to rotor 1, embodiments disclosed herein use a locking mechanism to selectively provide a rotational link between housing 2 and rotor 1. In one or more embodiments, the locking mechanism may be a locking clutch, which may be referred to as a one-way clutch.

As described above, transmitting torque from housing 2 to rotor 1 may be desired when a downhole motor stalls during drilling or when a drill bit becomes stuck. FIG. 2C shows a detailed view of a locking mechanism in accordance with embodiments disclosed herein. In this embodiment, the locking mechanism is disposed at the lower end of rotor 1 (position on the motor bearing assembly 5 is shown in FIG. 2A). One advantage of locating a locking mechanism on the lower end of rotor 1 is that rotor 1 may be strongest at its lower end.

In some embodiments, the lower end of rotor 1 may be able to withstand three to four times the amount of torque than the upper end. Disposing a locking mechanism at the lower end also prevents large amounts of torque from being transmitted through other, weaker portions of rotor 1. However, one of ordinary skill in the art will appreciate that a locking mechanism may also be disposed at other locations (including the upper end) of a downhole motor without departing from the scope of embodiments disclosed herein.

Referring again to FIGS. 2B and 2C, a locking clutch 20 used in accordance with one embodiment of the present disclosure is shown (without internal components).

Locking clutch 20 is designed to engage based on relative rotation between rotor 1 and housing 2. When the downhole motor is operating correctly during drilling, rotor 1 will be turning at a higher speed (e.g., 1000 revolutions per minute) than housing 2, which may be turning at a substantially constant, low speed (e.g., 40 revolutions per minute).

Should the drill bit rotation become restricted, rotor 1 slows or ceases to turn, but the housing, driven at drillstring speed, will continue to turn the rotor.

To prevent stalling of the drill bit, locking clutch 20 will engage and apply torque from housing (i.e., a stator) 2 to rotor 1 when the rotational speed of rotor 1 no longer exceeds that of the rotational speed of the housing (i.e., when the relative rotation between housing 2 and rotor 1 is zero). When this occurs, the locking clutch will mechanically engage, or couple the rotating housing with the rotor, and in doing so, impart rotation to the bit and free it from being stuck. Following engagement, if the drill bit is freed and rotation of rotor 1 is able to resume as driven by the turbine vanes, locking clutch 20 will first mechanically, then centrifugally disengage rotor 2 from housing 1 and thus allow normal operation of the motor to continue. Because locking clutch 20 is able to ratchet and disengage on its own once rotor 1 exceeds the speed of the drillstring and housing, there is no need to trip out the drillstring to repair or reset the motor assembly. The locking clutch is fully disclosed in co-pending U.S. application Ser. No. 11/742,397, and incorporated herein by reference in its entirety.

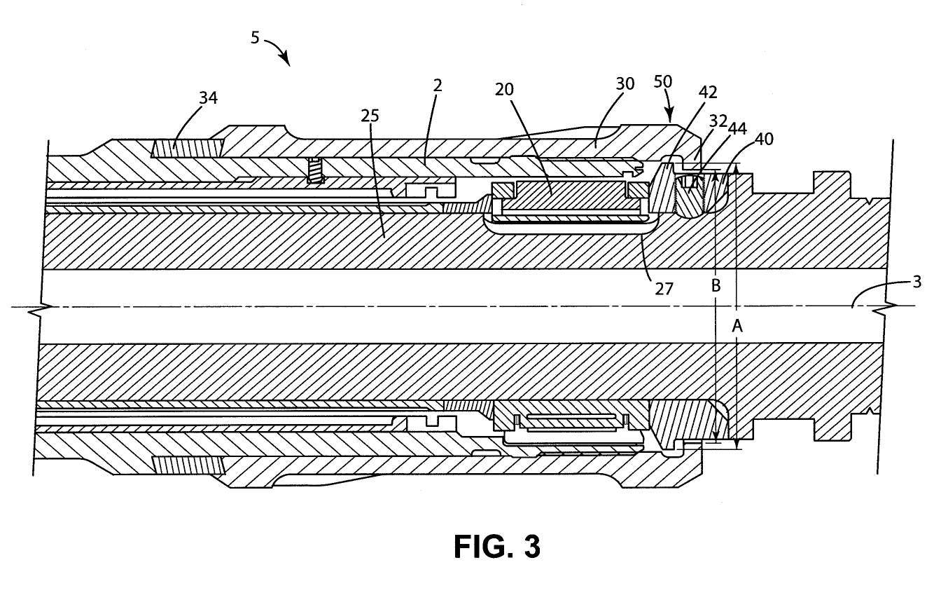

Referring now to FIG. 3, a cross-sectional view of a lower end of the motor bearing assembly 5 in accordance with embodiments of the present disclosure is shown. As previously described, a shaft 25 passes through the center on a central axis 3 of the motor bearing assembly 5 and provides rotation to the drill bit (not shown), which is attached to a distal end of the shaft 25. Further, the locking clutch 20 is assembled about the shaft 25. As shown, a shaft section 27 of the shaft 25 over which the locking clutch 20 is positioned has milled pockets, which reduce the cross-sectional area of the shaft section 27 as compared to the diameter of the remaining length of the shaft 25. The milled pockets, which are formed to accommodate the locking clutch 20, may weaken the shaft 25 in the shaft section 27 because of the smaller cross-sectional area. In particular, the shaft section 27 may be more susceptible to failure when the shaft section 27 is subjected to bending loads. The bending loads on the shaft 25 may occur when the turbine is operated in directional drilling applications, which may induce side loads on the shaft of the turbine.

In the event that the shaft 25 is severed due to loads experienced during drilling, particularly in shaft section 27, a “catch device” 50 may be incorporated into the motor bearing assembly 5 below the clutch to prevent a severed lower section of the shaft 25 from completely disconnecting from the motor bearing assembly 5 and falling into the wellbore. The catch device 50 of the motor bearing assembly 5 may include a spacer 40 attached to the shaft 25, which may be attached to the shaft 25 using set screws 44 as shown. The spacer 40 has a flange 42 that is oriented to extend radially outward from the shaft 25. While set screws 44 are shown as the attachment means, those skilled in the art will understand other attachment means including threading, press-fitting, or welding may be used to attach the spacer 40 to the shaft 25. Further, in certain embodiments, the spacer 40 may be integrally formed with the shaft 25. Additionally, the catch device 50 includes a mandrel stabilizer 30 that is assembled over the housing 2 of the motor bearing assembly 5. The mandrel stabilizer 30 includes a lip 32 which is oriented to extend radially inward towards the shaft 25. In other embodiments, the lip may be formed on the housing itself. Still further, in certain embodiments, components downhole of the flange (e.g., bearing packages) may serve as a lip on which the flange may contact in the event that the shaft severed and the falls downhole.

The flange 42 of the spacer 40 is configured to contact the lip 32 of the mandrel stabilizer 30 when the shaft 25 breaks in a section of the shaft 25 above the spacer 40 (uphole of the spacer 40 when the turbine is in the wellbore). Particularly, as described above, the shaft 25 is most susceptible to failure in the milled pocket shaft section 27 located just above the spacer 40. In order for the flange 42 of the spacer 40 to contact the lip 32 of the mandrel stabilizer 30, the flange 42 is configured to have an outer diameter A that is greater than an inner diameter B of the lip 32. Further, when assembled, the lip 32 of the mandrel stabilizer 30 is positioned downhole from the flange 42 of the spacer 40. Thus, in the event that a lower section of the shaft 25 is severed, the lip 32 of the stabilizer 30 is able to interfere with the flange 42 of the spacer 40, and thereby prevent the spacer 40 and the severed shaft from falling into the wellbore.

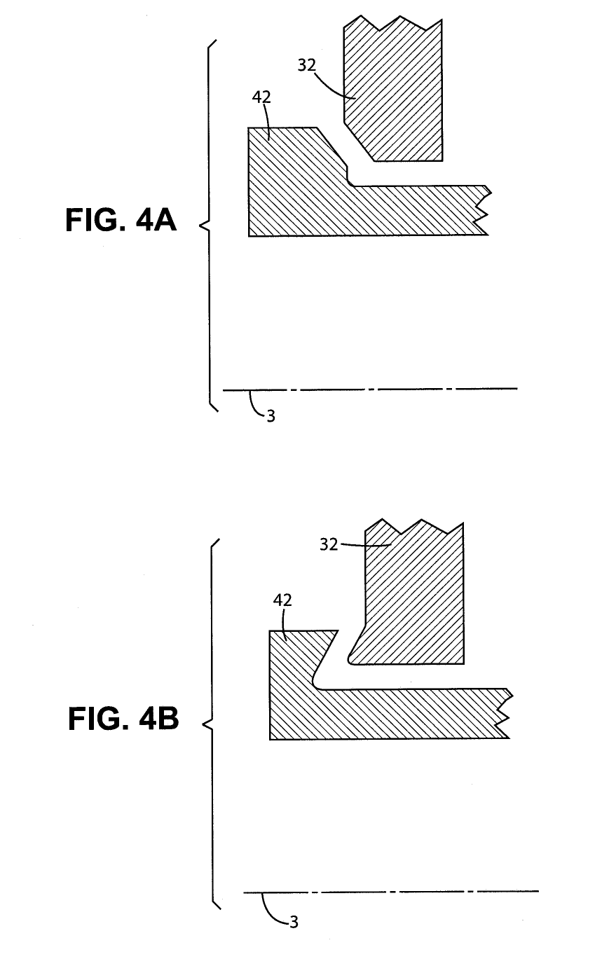

In certain embodiments, the flange 42 of the spacer 40 and the lip 32 of the mandrel stabilizer 30 may have corresponding angled profiles configured to engage each other. For example, as shown in FIG. 3, the contact surfaces of the flange 42 and the lip 32 are substantially perpendicular to the central axis 3 of the motor bearing assembly 5. Referring now to FIGS. 4A and 4B, angled contact surfaces of the flange 42 and the lip 32 in accordance with embodiments of the present disclosure are shown. The amount with which the surfaces are angled may vary and may be specified by one of ordinary skill in the art. The angled contact surfaces may help with alignment about the central axis 3 of a severed shaft by restricting the amount of movement of the severed shaft in a radial direction off the central axis 3. This may be beneficial to prevent the severed shaft from becoming misaligned with respect to the motor bearing assembly 5 and possibly hanging up in the wellbore during retrieval.

Generally, the shaft 25 may break in the milled pocket shaft section 27, as previously described. However, it is possible for the shaft 25 to break in a location up-hole of the shaft section 27. Therefore, the amount of weight that must be supported by the lip 32 (in contact with the flange 42) may vary depending on the length of the severed shaft 25. Thus, the spacer 40 may be configured to support at least several times the weight of a full length of the shaft 25 and a bit attached to an end of the shaft 25. For example, the spacer 40 may be configured to axially support at least the weight of a full length of the shaft and the bit. Those skilled in the art will understand that additional factors such as continued downward hydraulic thrust through the turbodrill, friction and drag caused from cuttings in the borehole, and other factors may contribute to the weight applied to the flange (on the spacer) as the turbodrill is removed from the borehole. The flange is configured to support additional weight caused by such factors.

Referring back to FIG. 3, to assemble the catch device 50 onto the motor bearing assembly 5, a shaft sub-assembly (which includes the spacer 40 attached to the shaft 25) may be inserted into a lower end of the housing 2. Detailed assembly of a turbine shaft into a turbine is understood by those skilled in the art, and therefore will not be discussed in further detail. Next, the mandrel stabilizer 30 may be assembled onto the housing 2 and over the shaft 25. The mandrel stabilizer 30 is installed onto the housing 2 such that the lip 32 of the mandrel stabilizer 30 “traps” the shaft 25 by preventing the spacer 42 from moving axially downward past the lip 32. In certain embodiments, the lip 32 may include a separate component or components, for example a ring or set screws protruding inwardly from the housing 2. A spacer ring 34 may be used to position the mandrel stabilizer 30 at a specified axial position on the housing 2 relative to the spacer 40. The spacer ring 34 may position the mandrel stabilizer 30 on the housing 2 such that a specified “gap” is formed between the flange 42 of the spacer 40 and the lip 32 of the mandrel stabilizer 30. The amount of gap between the flange 42 and the lip 32 may depend upon certain clearances that may be required between components in the turbodrill, or other factors known to those skilled in the art.

Advantageously, embodiments of the present disclosure may prevent a severed shaft from falling into a wellbore, and allow retrieval of the severed shaft with the turbine. The catch device minimizes costs by eliminating the need for fishing operations to retrieve broken shafts and bits from a wellbore. Therefore, less rig time may be spent fishing for lost equipment in the wellbore, and more time spent on actually drilling the well. Additionally, embodiments disclosed herein provide simplicity in that the catch device may easily be retrofitted to existing turbodrills with minimal component replacement or other modification costs.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A turbodrill comprising:
a housing having a central axis;
a motor assembly disposed within the housing and comprising non-rotating stator vanes fixed to the housing, and a rotor assembly having rotating vanes fixed to a shaft of the turbodrill;
a locking clutch configured to selectively transmit torque from the turbine housing to the rotor by preventing rotation of the housing and the rotor relative to each; and
a catch device configured to retain a severed lower section of the shaft with the turbodrill.

2. The turbodrill of claim 1, wherein the catch device comprises a flange disposed on the shaft and a lip disposed on the housing, wherein an outer diameter of the flange is greater than an inner diameter of the lip on the housing.

3. The turbodrill of claim 1, wherein the flange on the shaft is configured to axially support at least the weight of the shaft.

4. The turbodrill of claim 1, wherein the flange is integral to the shaft.

5. The turbodrill of claim 1, wherein the flange is threadably attached to the shaft.

6. The turbodrill of claim 1, further comprising set screws configured to attach the flange to the shaft.

7. The turbodrill of claim 1, wherein a surface of the flange and a surface of the lip are angled with respect to the central axis of the housing.

8. The turbodrill of claim 1, wherein the catch device is disposed downhole of the locking clutch.

9. The turbodrill of claim 1, wherein the catch device is disposed downhole of a reduced strength shaft section of the shaft.

10. A method of assembling a catch device on a turbodrill, the method comprising:
inserting a shaft sub-assembly having a flange disposed thereon into a lower end of a housing of the turbodrill;
providing a lip on a component downhole of the flange, wherein the lip is configured to engage the flange on the shaft and prevent the flange from travelling in an axial direction downward past the lip.

11. The method of claim 10, further comprising attaching the flange to the shaft with set screws.

12. The method of claim 10, further comprising threadably attaching the flange to the shaft.

13. The method of claim 10, wherein an outer diameter of the flange is larger than an inner diameter of the lip.

14. The method of claim 10, further comprising positioning the catch device downhole of a reduced strength shaft section of the shaft.

15. A method of retrieving a severed lower shaft of a turbodrill from a wellbore with the turbodrill, the method comprising:
providing a lip disposed on a housing component of the turbodrill downhole of a flange attached to the lower shaft, wherein the lip is configured to interfere with the flange;
retrieving the severed lower shaft using the housing of the turbodrill.

16. The method of claim 15, further comprising supporting at least the weight of the shaft with the flange with the lip.

17. The method of claim 15, wherein an outer diameter of the flange is larger than an inner diameter of the lip.
